(19) United States
(12) Patent Application Publication
(10) Pub. No.: US 2007/0077973 A1
(43) Pub. Date: Apr. 5, 2007

(54) Electronic device with high efficiency and wide bandwidth internal antenna

(75) Inventors: Chien-Yi Wu, Kaohsiung City (TW); Chi-Yin Fang, Pingtung City (TW)

Correspondence Address: DAVIDSON BERQUIST JACKSON & GOWDEY LLP, 4300 WILSON BLVD., 7TH FLOOR, ARLINGTON, VA, 22203, US

(73) Assignee: Quanta Computer Inc., Kuei Shan Hsiang (TW)

(21) Appl. No.: 11/498,088

(22) Filed: Aug. 3, 2006

(30) Foreign Application Priority Data
Oct. 4, 2005 (TW) 094134649

(51) Int. Cl. H04M 1/00

(52) U.S. Cl. 455/575.7

(57) ABSTRACT

An electronic device includes a circuit board and an antenna. The circuit board has opposite first and second edges. The antenna includes a grounding element, a substrate, feeding and grounding ports, and first and second radiating elements. The grounding element is formed on the circuit board. The substrate has opposite first and second edges that are respectively distal from and proximate to the first edge of the circuit board. The feeding and grounding ports are provided along the first edge of the circuit board. The first radiating element has a first feeding point and a grounding point that are disposed along the second edge of the substrate and that are connected respectively to the first feeding port and the grounding port. The second radiating element has a second feeding point that is disposed on the second edge of the substrate and that is connected to the second feeding port.

### CROSS-REFERENCE TO RELATED APPLICATION

This application claims priority of Taiwanese application no. 094134649, filed on Oct. 4, 2005.

### BACKGROUND OF THE INVENTION

1. Field of the Invention

This invention relates to an electronic device, more particularly to an electronic device that includes a high efficiency and wide bandwidth internal antenna.

2. Description of the Related Art

Recently, antennas used in mobile phones are external antennas of monopole and helical types. However, the external antennas are prone to damage. Therefore, internal antennas, such as planar inverted-F antennas (PIFA) or microstrip antennas, have been developed. However, the performance, such as operating bandwidth and antenna efficiency, of the internal antennas degrades as the physical size thereof is reduced.

### SUMMARY OF THE INVENTION

Therefore, the object of the present invention is to provide an electronic device that includes a high efficiency and wide bandwidth internal antenna.

According to the present invention, an electronic device comprises a casing, a circuit board, and an internal antenna. The circuit board is mounted in the casing, and has first and second surfaces that are opposite to each other in a first direction. The first surface of the circuit board has first and second edges that are opposite to each other in a second direction transverse to the first direction. The internal antenna is disposed in the casing, and includes a grounding element, first and second feeding ports, a grounding port, and first and second radiating elements. The grounding element is provided on the second surface of the circuit board. The first and second feeding ports and the grounding port are provided along the first edge of the first surface of the circuit board. The substrate has first and second edges that opposite to each other in the second direction. The first and second edges of the substrate are respectively distal from and proximate to the first edge of the circuit board. The first radiating element is formed on the substrate, and has a first feeding point and a grounding point that are disposed along the second edge of the substrate and that are connected respectively to the first feeding port and the grounding port. The second radiating element is formed on the substrate, is separated from the first radiating element, and has a second feeding point that is disposed on the second edge of the substrate and that is connected to the second feeding port.

### BRIEF DESCRIPTION OF THE DRAWINGS

Other features and advantages of the present invention will become apparent in the following detailed description of the preferred embodiments with reference to the accompanying drawings, of which:

FIG. 1 is an exploded perspective view of the first preferred embodiment of an electronic device according to this invention;

FIG. 2 is a schematic view to illustrate an internal antenna of the first preferred embodiment;

FIG. 3 is a plot to illustrate exemplary voltage standing wave ratio (VSWR) achieved by the internal antenna of the first preferred embodiment;

FIGS. 4 and 5 are plots to illustrate radiation patterns of the internal antenna of the first preferred embodiment;

FIG. 6 is a schematic view to illustrate an internal antenna of the second preferred embodiment of an electronic device according to this invention; and

FIG. 7 is a schematic view to illustrate an internal antenna of the third preferred embodiment of an electronic device according to this invention.

### DETAILED DESCRIPTION OF THE PREFERRED EMBODIMENTS

Before the present invention is described in greater detail, it should be noted that like elements are denoted by the same reference numerals throughout the disclosure.

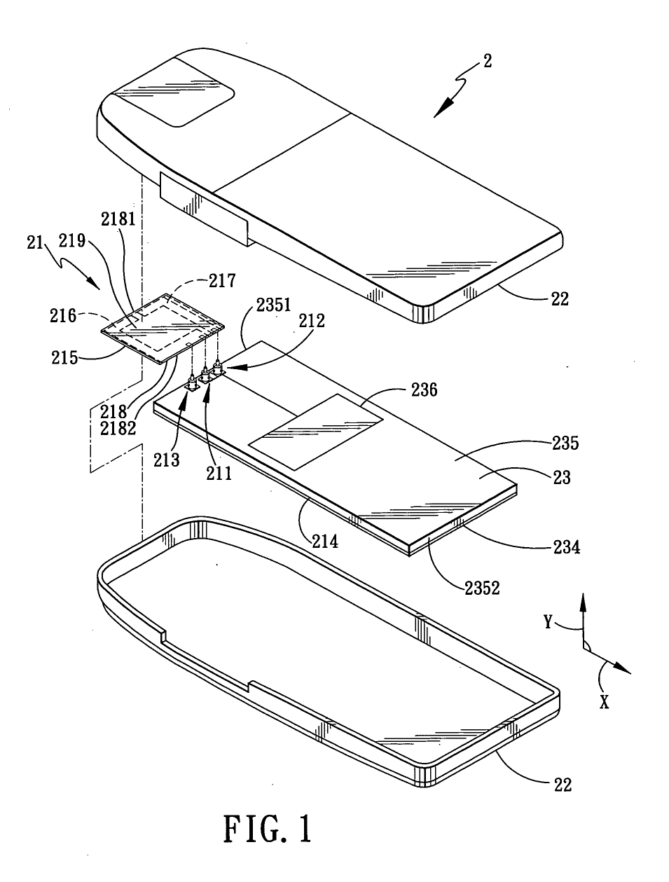

Referring to FIG. 1, the first preferred embodiment of an electronic device 2 according to this invention is shown to include a casing 22, a circuit board 23, and an internal antenna 21.

The electronic device 2 of this embodiment is in the form of a mobile phone.

The circuit board 23 is mounted in the casing 22, and has first and second surfaces 235, 234 that are opposite to each other in a first direction, as indicated by arrow (Y). The first surface 235 of the circuit board 23 has first and second edges 2351, 2352 that are opposite to each other in a second direction, as indicated by arrow (X), transverse to the first direction (Y).

The electronic device 2 further includes transceiver circuit 236 that is mounted on the first surface 235 of the circuit board 23, and that is controlled by the electronic device 2 so as to transmit and receive communication signals via the internal antenna 21, in a manner well known in the art.

The internal antenna 21 is a multi-band antenna, is disposed in the casing 22, and includes first and second feeding ports 211, 212, a grounding element 214, a grounding port 213, a substrate 215, and first and second radiating elements 216, 217.

The first and second feeding ports 211, 212 are provided along the first edge 2351 of the first surface 235 of the circuit board 23, and are coupled to the transceiver circuit 236. In this embodiment, each of the first and second feeding ports 211, 212 is a conductive pin. In an alternative embodiment, each of the first and second feeding ports 211, 212 may be a conductive spring arm or a conductive protrusion.

The grounding element 214 is formed on the second surface 234 of the circuit board 23.

The grounding port 213 is provided on the first edge 2351 of the first surface 235 of the circuit board 23 and is coupled to the grounding element 214. In this embodiment, the grounding port 213, like the first and second feeding ports 211, 212, is a conductive pin. In an alternative embodiment, the grounding port 213 may be a conductive spring arm or a conductive protrusion.

The substrate 215 of the internal antenna 21 has first and second surfaces 218, 219 that are opposite to each other in the first direction (Y). The first surface 218 of the substrate 215 has first and second edges 2181, 2182 that are opposite to each other in the second direction (X). In this embodiment, the substrate 215 is a flexible printed circuit board (FPCB) that is made from a thin film material. As such, the internal antenna 21 may be shaped to fit in the casing 22. In an alternative embodiment, the substrate 215 of the internal antenna 21 is a rigid PCB.

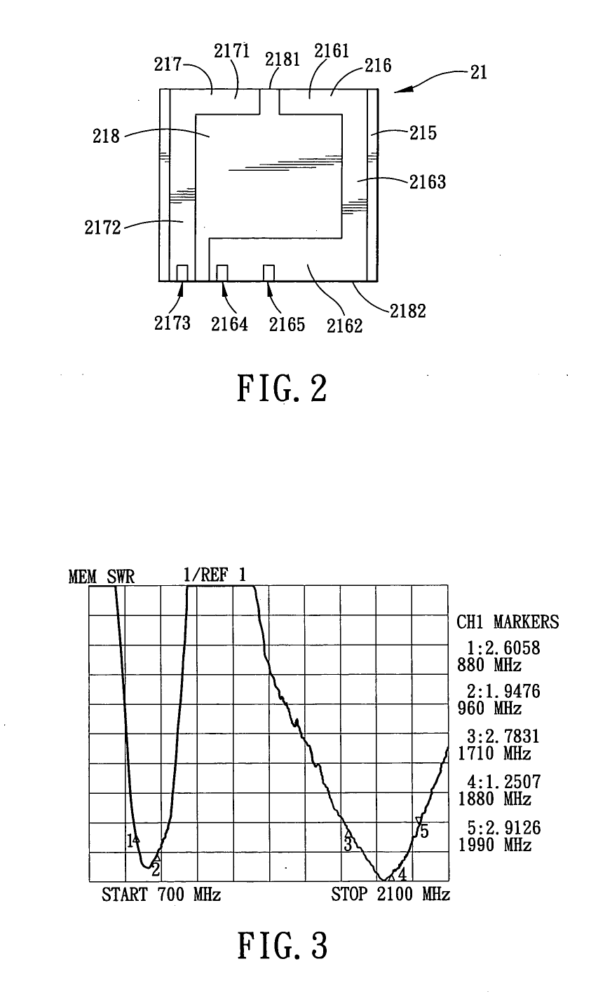

With further reference to FIG. 2, the first radiating element 216 of the internal antenna 21 is formed on the first surface 218 of the substrate 215, is a generally C-shaped shorted-monopole, and includes first and second end portions 2161, 2162, each of which is disposed at a respective one of the first and second edges 2181, 2182 of the first surface 218 of the substrate 215, and an interconnecting portion 2163 that interconnects the first and second end portions 2161, 2162 of the first radiating element 216. In this embodiment, the first radiating element 216 has a first feeding point 2164 and a grounding point 2165 that are disposed along the second edge 2182 of the first surface 218 of the substrate 215 and that are provided on the second end portion 2162 of the first radiating element 216. The first feeding point 2164 of the first radiating element 216 is connected to the first feeding port 211, whereas the grounding point 2165 of the first radiating element 216 is connected to the grounding port 213.

The second radiating element 217 of the internal antenna 21 is formed on the first surface 218 of the substrate 215, is separated from the first radiating element 216, is an L-shaped monopole, and includes first and second radiating portions 2171, 2172. In this embodiment, the second radiating element 217 has a second feeding point 2173 that is disposed on the second edge 2182 of the first surface 218 of the substrate 215, that is provided on the second radiating portion 2172 of the second radiating element 217, and that is connected to the second feeding port 212.

In this embodiment, the first radiating element 216 of the internal antenna 21 operates in the GSM (900 MHz) frequency band, whereas the second radiating element 217 of the internal antenna 21 operates in the DCS/PCS (1800/1900 MHz) frequency band.

It is noted that since the first feeding point 2164 of the first radiating element 216 is coupled to the transceiver circuit 236 through the first feeding port 211, and the second feeding point 2173 of the second radiating element 217 is coupled to the transceiver circuit 236 through the second feeding port 212, undesired coupling and interference between the first and second radiating elements 216, 217 can be minimized.

As best shown in FIG. 1, the substrate 215 is disposed such that the first and second edges 2181, 2182 of the first surface 218 of the substrate 215 are respectively distal from and proximate to the first edge 2351 of the circuit board 23. The construction as such minimizes overlapping area between each of the first and second radiating elements 216, 217 and the grounding element 214. Accordingly, the internal antenna 21 has a wider operating bandwidth and is more efficient. Furthermore, the substrate 215 may be brought closer to the circuit board 23 without causing interference between each of the first and second radiating elements 216, 217 and the grounding element 214.

The electronic device 2 further includes an adhesive member (not shown) that is provided on the second surface 219 of the substrate 215 for attaching the substrate 215 to the casing 22.

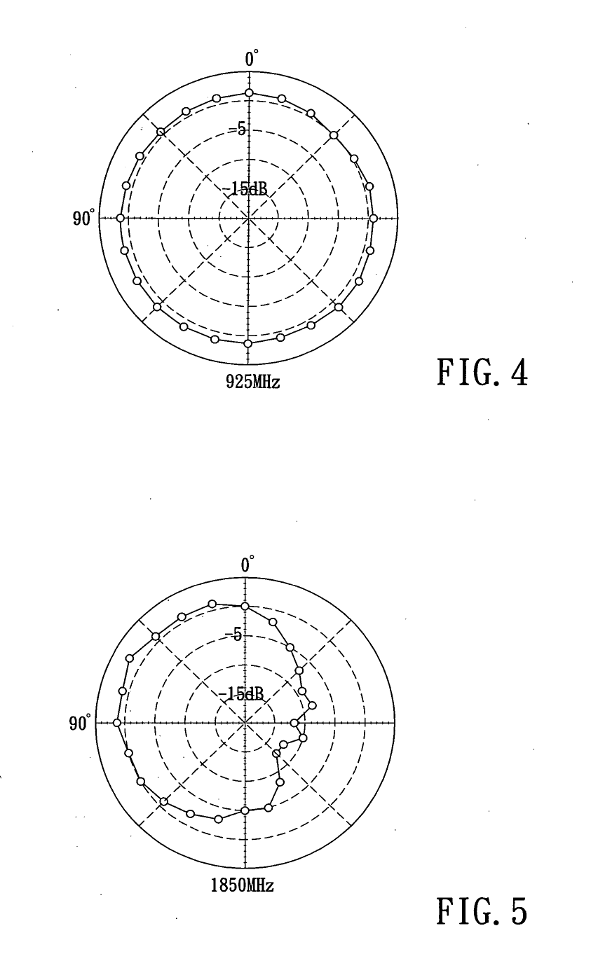

Based on experimental results, with further reference to FIG. 3, the internal antenna 21 achieves voltage standing wave ratios (VSWR) of 2.6058, 1.9476, 2.7831, 1.2507, and 2.9126 when operated at 880 MHz, 960 MHz, 1710 MHz, 1880 MHz, and 1990 MHz, respectively. Moreover, as illustrated in FIG. 4, the internal antenna 21 has an omnidirectional radiation pattern when operated at 925 MHz. Further, as illustrated in FIG. 5, the internal antenna 21 has a substantially omnidirectional radiation pattern when operated at 1850 MHz.

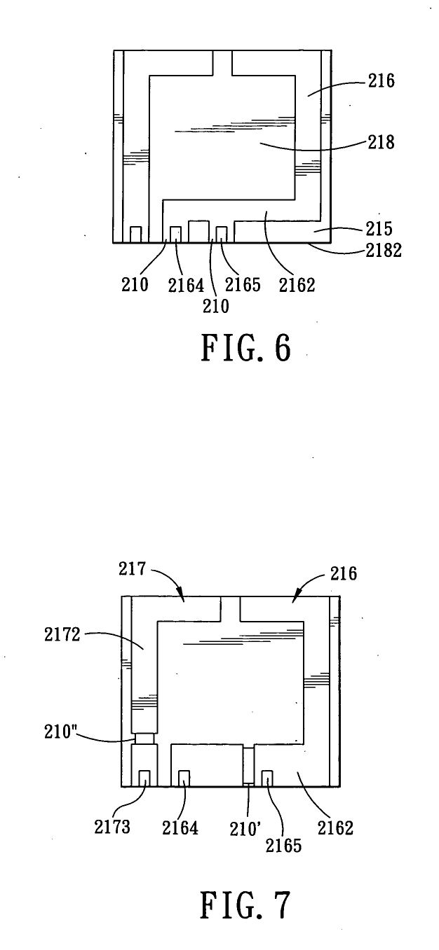

FIG. 6 illustrates the second preferred embodiment of an electronic device 2 (see FIG. 1) according to this invention. When compared to the previous embodiment, the second end portion 2162 of the first radiating element 216 is disposed adjacent to the second edge 2182 of the first surface 218 of the substrate 215. The first radiating element 216 further includes a pair of extended portions 210, each of which extends transversely from the second end portion 2162 of the first radiating element 216 to the second edge 2182 of the substrate 215. Each of the first feeding point 2164 and the grounding point 2165 is provided on a respective one of the extended portions 210 of the first radiating element 216. The construction as such further minimizes the overlapping area between each of the first and second radiating elements 216, 217, and the grounding element 214 (see FIG. 1).

FIG. 7 illustrates the third preferred embodiment of an electronic device 2 (see FIG. 1) according to this invention. When compared to the first preferred embodiment, the second end portion 2162 of the first radiating element 216 is divided into two sections. Each of the first feeding point 2164 and the grounding point 2165 of the first radiating element 216 is provided on a respective one of the sections of the second end portion 2162 of the first radiating element 216. The first radiating element 216 further has a first matching element 210′ that matches impedance of the first feeding port 211 (see FIG. 1) to that of the first feeding point 2164 and that interconnects the sections of the second end portion 2162 of the first radiating element 216.

Furthermore, the second radiating portion 2172 of the second radiating element 217 is divided into two sections. The second feeding point 2173 of the second radiating element 217 is provided on one of the sections of the second radiating portion 2172. The second radiating element 217 further has a matching element 210″ that matches impedance of the second feeding port 212 (see FIG. 1) to that of the second feeding point 2173, and that interconnects the sections of the second radiating portion 2172 of the second radiating element 217.

The construction as such further widens the operating bandwidth and increases the antenna efficiency of the internal antenna 21.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. An electronic device, comprising:
a casing;
a circuit board mounted in said casing, and having first and second surfaces that are opposite to each other in a first direction, said first surface of said circuit board having first and second edges that are opposite to each other in a second direction transverse to the first direction; and
an internal antenna disposed in said casing, and including
a grounding element provided on said second surface of said circuit board,
first and second feeding ports and a grounding port provided along said first edge of said first surface of said circuit board,
a substrate having first and second edges opposite to each other in the second direction, said first and second edges of said substrate being respectively distal from and proximate to said first edge of said circuit board,
a first radiating element formed on said substrate, and having a first feeding point and a grounding point that are disposed along said second edge of said substrate and that are connected respectively to said first feeding port and said grounding port, and
a second radiating element formed on said substrate, separated from said first radiating element, and having a second feeding point that is disposed on said second edge of said substrate and that is connected to said second feeding port.

2. The electronic device as claimed in claim 1, wherein said substrate is a flexible printed circuit board.

3. The electronic device as claimed in claim 1, wherein said first radiating element is generally C-shaped.

4. The electronic device as claimed in claim 1, wherein said second radiating element is generally L-shaped.

5. The electronic device as claimed in claim 1, wherein said first radiating element has an end portion-disposed adjacent to said second edge of said substrate, and a pair of extended portions, each of which extends from said end portion of said first radiating element to said second edge of said substrate, each of said first feeding point and said grounding point being provided on a respective one of said extended portions of said first radiating element.

6. The electronic device as claimed in claim 1, wherein said first radiating element has an end portion that is disposed at said second edge of said substrate and that is divided into two sections, and a matching element that matches impedance of said first feeding port to that of said first feeding point and that interconnects said sections of said end portion of said first radiating element, each of said first feeding point and said grounding point of said first radiating element being provided on a respective one of said sections of said end portion of said first radiating element.

7. The electronic device as claimed in claim 1, wherein said second radiating element has a portion that is divided into two sections, and a matching element that matches impedance of said second feeding port to that of said second feeding point and that interconnects said sections of said portion of said second radiating element, said second feeding point of said second radiating element being provided on one of said sections of said portion of said second radiating element.

8. The electronic device as claimed in claim 1, wherein said first radiating element operates in a first frequency band, said second radiating element operating in a second frequency band different from the first frequency band.

9. The electronic device as claimed in claim 1, wherein said first radiating element operates in GSM frequency band.

10. The electronic device as claimed in claim 1, wherein said second radiating element operates in DCS/PCS frequency band.
